(19) United States
(12) Patent Application Publication
(10) Pub. No.: US 2024/0017816 A1
(43) Pub. Date: Jan. 18, 2024

(54) WING ELEMENT STRUCTURE, WING STRUCTURE AND FLAPPING-WING AIRCRAFT

(71) Applicant: WESTLAKE UNIVERSITY, Hangzhou, Zhejiang (CN)

(72) Inventors: Wei LI, Hangzhou, Zhejiang (CN); Bing LUO, Hangzhou, Zhejiang (CN); Weicheng CUI, Hangzhou, Zhejiang (CN)

(21) Appl. No.: 18/038,218

(22) PCT Filed: Nov. 23, 2020
(86) PCT No.: PCT/CN2020/130770

§ 371 Date: May 23, 2023

(51) Int. Cl. B64C 3/48; B64C 33/02

(52) U.S. Cl. CPC B64C 3/48; B64C 33/02

(57) ABSTRACT

Embodiments of the present disclosure provide a wing element structure, a wing structure, and a flapping-wing aircraft. The wing element structure includes a plurality of wing element units, the adjacent wing element units being connected by an airfoil control unit and awing element outer edge connector, wherein each of the wing element units includes a plurality of interconnected wing element edge pieces and a wing link connector, and the wing link connector in each of the wing element units is correspondingly connected to a wing lever group of an aircraft. Embodiments of the present disclosure provide the wing element structure with large-scale variable airfoil characteristics in both chord length and curvature. The movement of the wing element structure is driven by the movement of the wing lever group. The wing structure has the ability of variable airfoil shape and large-scale variable pitch angle, the ability to swing vertically in a large range along the plane where the main body of the aircraft is located and the ability to swing longitudinally in a large range along the main body of the aircraft. The wing structure can be adjusted for complex flow fields or environments, greatly improve the speed and efficiency of movement, and achieve high maneuverability.

### TECHNICAL FIELD

The present disclosure relates to the field of navigation devices, and in particular, to a wing element structure, a wing structure and a flapping-wing aircraft.

### BACKGROUND OF THE INVENTION

Most of the aircrafts in the prior art use a fixed-wing structure or a relatively limited morphing wing structure, which cannot be adjusted for the actual navigation or flight environment or complex flow field, thereby resulting in poor navigation or flight efficiency, poor stability, and inability to achieve high maneuverability.

### SUMMARY OF THE INVENTION

An object of the embodiments of the present disclosure is to provide a wing structure for an aircraft and an aircraft to solve the problem in the prior art that the wing structure and the aircraft cannot be adjusted for actual navigation or flight environments or complex flow fields, and problem of poor navigation or flight efficiency, poor stability, and inability to achieve high maneuverability.

In order to solve the above technical problems, the embodiments of the present disclosure adopt the following technical solution: a wing element structure for an aircraft, comprising a plurality of wing element units, the adjacent wing element units being connected by an airfoil control unit and awing element outer edge connector, wherein each of the wing element units includes a plurality of interconnected wing element edge pieces and a wing link connector, and the wing link connector in each of the wing element units is correspondingly connected to a wing lever group of an aircraft.

In some embodiments, the plurality of wing element units comprise a wing element leading edge unit and a wing element trailing edge unit, and at least one wing element middle unit is disposed between the wing element leading edge unit and the wing element trailing edge unit.

In some embodiments, the wing element leading edge unit comprises a wing element leading edge arc piece, a first wing element edge piece, an eighth wing element edge piece, and a wing leading edge link connector, first ends of the first wing element edge piece and of the eighth wing element edge piece are respectively connected with a first end and a second end of the wing element leading edge arc piece, and second ends of the first wing element edge piece and of the eighth wing element edge piece are respectively connected with a first rotary bearing and a sixth rotary bearing, the first rotary bearing and the sixth rotating bearing being connected through a first wing element unit support which passes through and is connected with the wing leading edge link connector.

In some embodiments, the wing element trailing edge unit comprises awing element trailing edge wedge piece, a fourth wing element edge piece, a fifth wing element edge piece and a wing trailing edge link connector, first ends of the fourth wing element edge piece and of the fifth wing element edge piece are respectively connected with a first end and a second end of the wing element trailing edge wedge piece, and second ends of the fourth wing element edge piece and of the fifth wing element edge piece are respectively connected with a third rotary bearing and a fourth rotary bearing, the third rotary bearing and the fourth rotary bearing being connected through a third wing element unit support which passes through and is connected with the wing trailing edge link connector.

In some embodiments, the wing element middle unit comprises a second wing element edge piece, a third wing element edge piece, a sixth wing element edge piece, a seventh wing element edge piece and a wing middle link connector, first ends of the second wing element edge piece and of the third wing element edge piece are connected through a second rotary bearing, and first ends of the sixth wing element edge piece and of the seventh wing element edge piece are connected through a fifth rotary bearing, the second rotary bearing and the fifth rotary bearing being connected through a second wing element unit support which passes through and is connected with the wing middle link connector.

In some embodiments, the wing element edge pieces of adjacent wing element units are connected by the wing element outer edge connector, and the wing element outer edge connector includes a flexible connector and a sliding cover, the flexible connector telescopically connects the adjacent wing element edge pieces, one end of the sliding cover is fixedly connected with an end of one of the wing element edge pieces connected, and the other end of the sliding cover is slidably connected with an end of another adjacent wing element edge piece.

In some embodiments, the airfoil control unit comprises a slip ring link, a slip ring and a sliding rod, one end of the slip ring link is connected to a side of a first wing link connector of the first wing element unit, the other end of the slip ring link is connected to the slip ring, the sliding rod is arranged on a side of a second wing link connector of the second wing element unit adjacent to the first wing element unit and extends toward the direction of the first wing link connector, and the sliding ring is sleeved on the sliding rod and can slide back and forth along the sliding rod.

In some embodiments, a sliding rod base is provided on the top of the sliding rod, two sliding rod base hinge supports are respectively provided on the opposite first and second sides of the sliding rod base, and each of the sliding rod base hinge supports is connected with a corresponding slip ring hinge support on the slip ring through a lever group.

In some embodiments, on the first side or the second side of the sliding rod base, the lever group comprises a front rod and a rear rod that are connected to each other, a first end of the front rod is connected with the corresponding sliding rod base hinge support, a second end of the front rod is connected with the corresponding wing element edge piece through a hinge support, the middle part of the front rod is connected to a first end of the rear rod through another hinged support, and a second end of the rear rod is connected to the corresponding slip ring hinge support on the slip ring.

An embodiment of the present disclosure further provides a wing structure comprising the wing element structure of any of the solutions described above.

An embodiment of the present disclosure further provides an aircraft structure employing the wing structure in the solution described above.

Embodiments of the present disclosure have large-scale deformable wing characteristics. The wing structure has the ability of variable airfoil and large-scale variable pitch angle, the ability to swing vertically in a large range along the plane where the main body of the aircraft is located and the ability to swing longitudinally in a large range along the main body of the aircraft. The wing structure can be adjusted for complex flow fields or environments, greatly improve the speed and efficiency of movement, and achieve high maneuverability.

### BRIEF DESCRIPTION OF THE DRAWINGS

FIG. 1 is a schematic structural diagram of a wing structure with three multi-lever group structures according to an embodiment of the present disclosure;

FIG. 2 is a cross-sectional view of a wing element structure provided by an embodiment of the present disclosure;

FIG. 3 is a schematic three-dimensional structural diagram of a wing element structure provided by an embodiment of the present disclosure;

FIG. 4 is a schematic connection diagram of a wing element structure provided by an embodiment of the present disclosure;

FIG. 5 is a schematic structural diagram of an airfoil control unit in a wing element structure according to an embodiment of the disclosure;

FIG. 6 is a schematic structural diagram of an airfoil control unit in a wing element structure according to an embodiment of the disclosure;

FIG. 7 is a schematic structural diagram of an airfoil control unit in a wing element structure according to an embodiment of the disclosure;

FIG. 8 is a schematic connection diagram of an airfoil control unit in a wing element structure according to the embodiment of the disclosure;

FIG. 9 is a schematic connection diagram of an airfoil control unit in a wing element structure according to the embodiment of the disclosure;

FIG. 10 is a schematic connection diagram of an airfoil control unit in a wing element structure according to the embodiment of the disclosure;

FIG. 11 is a schematic diagram of the pose change of the wing element structure according to an embodiment of the disclosure;

FIG. 12 is a schematic diagram of the pose change of the wing element structure according to an embodiment of the disclosure;

FIG. 13 is a schematic diagram of the pose change of the wing element structure according to an embodiment of the disclosure;

FIG. 14 is a schematic diagram of the pose change of the wing element structure according to an embodiment of the disclosure;

FIG. 15 is a schematic diagram of the pose change of the wing element structure according to an embodiment of the disclosure;

FIG. 16 is a schematic diagram of the pose change of the wing element structure according to an embodiment of the disclosure;

FIG. 17 is a schematic diagram of the pose change of the wing element structure according to an embodiment of the disclosure; and

FIG. 18 is a schematic diagram of the pose change of the wing element structure according to an embodiment of the disclosure.

### REFERENCE NUMBER

100—wing leading edge link; 200—wing middle link; 300—wing trailing edge link; 400—wing element outer frame; 110—wing leading edge link connector, 210—wing middle link connector, 310—wing trailing edge link connector, 500—first airfoil control unit; 600—second airfoil control unit;
1—wing element leading edge arc piece; 2—first wing element edge piece; 3—first wing element outer edge connector, 4—second wing element edge piece; 5—third wing element edge piece; 6—second wing element outer edge connector, 7—fourth wing element edge piece; 8—the wing element trailing edge wedge piece; 9—fifth wing element edge piece; 10—third wing element outer edge connector; 11—sixth wing element edge piece; 12—seventh wing element edge piece; 13—fourth wing element outer edge connector, 14—eighth wing element edge piece; 15—first rotary bearing; 16—second rotary bearing; 17—third rotary bearing; 18—fourth rotary bearing, 19—fifth rotary bearing; 20—sixth rotary bearing; 21—first wing element unit support; 22—second wing element unit support; 23—third wing element unit support; 24—first slip ring link; 25—first slip ring; 26—first sliding rod; 27—first straight rod; 28—first U-shaped rod; 29—first sliding rod base; 30—first sliding rod base hinge support; 31—second sliding rod base hinge support; 32—third sliding rod base hinge support; 33—fourth sliding rod base hinge support; 34—first lever group; 35—second lever group; 36—third lever group; 37—fourth lever group; 38—first slip ring hinge support; 39—second slip ring hinge support; 40—third slip ring hinge support; 41—fourth slip ring hinge support; 42—first rod; 43—second rod; 44—first hinge support; 45—second hinge support; 46—third rod; 47—fourth rod; 48—third hinge support; 49—fourth hinge support; 50—fifth rod; 51—sixth rod; 52—fifth hinge support; 53—sixth hinge support; 54—seventh rod; 55—eighth rod; 56—seventh hinge support; 57—eighth hinge support.

### DETAILED DESCRIPTION

Various aspects and features of the present disclosure are described herein with reference to the accompanying drawings.

It should be understood that various modifications may be made to the embodiments claimed herein. Therefore, the above description should not be regarded as limiting, but merely as exemplifications of embodiments. Those skilled in the art will envision other modifications within the scope and spirit of this disclosure.

The accompanying drawings, which are incorporated in and constitute a part of this specification, illustrate embodiments of the present disclosure and, together with the general description of the disclosure given above and the detailed description of the embodiments given below, serve to explain principles of the present disclosure.

These and other features of the present disclosure will become apparent from the following description of preferred forms of embodiments, given as non-limiting examples, with reference to the accompanying drawings.

It should also be understood that although the present disclosure has been described with reference to some specific examples, those skilled in the art will be able to realize many other equivalent forms of the present disclosure with certainty, which have the characteristics set forth in the claims and are therefore within the scope of protection thus limited.

The above and other aspects, features and advantages of the present disclosure will become more apparent in view of the following detailed description when taken in conjunction with the accompanying drawings.

Specific embodiments of the present disclosure are hereinafter described with reference to the accompanying drawings; however, it is to be understood that the claimed embodiments are merely examples of the disclosure, which may be embodied in various ways. Well-known and/or repeated functions and constructions have not been described in detail to avoid obscuring the present disclosure with unnecessary or redundant detail. Therefore, specific structural and functional details claimed herein are not intended to be limiting, but merely serve as a basis for the claims and a representative basis for teaching one skilled in the art to variously employ the present invention in substantially any suitable detailed structure.

This specification may use the phrases “in one embodiment,” “in another embodiment,” “in yet another embodiment,” or “in other embodiments”, which can all refer to one or more of the same or different embodiments according to the present disclosure.

Embodiments of the present disclosure provide a wing element structure, a wing structure, and a flapping-wing aircraft.

The wing structure described herein is made up of the wing element structure, and the wing structure is mounted on the flapping-wing aircraft. The flapping-wing aircraft here can realize sailing or flying, gliding and other high maneuvering actions based on the swing of the wing structure in the air or in the water. The structure of the flapping-wing aircraft here may be a bionic structure such as a bionic bird, a bionic fish, etc., or a structure such as an aircraft-type biplane. The present disclosure does not limit the specific structure of the aircraft.

The wing structure herein may also be called “flapping wing”, which is arranged at any position on the main body of the aircraft, for example, arranged on the side(s) of the main body of the aircraft, arranged on one side, or arranged on two symmetrical sides of the main body of the aircraft. The present disclosure does not limit the location of the wing structure, either.

The wing structure involved in the embodiments of the present disclosure may connect the wing element structure in the embodiments of the present disclosure through a multi-link structure, so as to realize the twisting deformation of the wing structure. Different wing structure forms can be realized according to the number of wing element units and airfoil control units used in each of the wing element structures, thereby realizing different swing gestures and swing degrees.

Specifically, the wing structure involved in the embodiment of the present disclosure includes at least one multi-link structure extending from the main body of the aircraft to the wingtip direction, and the wing element structures involved in the embodiments of the present disclosure are arranged between the multi-link structures. In the following embodiments of the present disclosure, it is taken as an example that the wing structure includes three multi-lever group structures, but the number is not limited. As shown in FIG. 1, in the wing structure according to the embodiment of the present disclosure, three multi-link structures are arranged in the leading edge part of the wing, the middle part of the wing and the trailing edge part of the wing respectively extending from the main body of the aircraft to the wing tip direction. The three multi-link structures are respectively awing leading edge multi-link structure a, a wing middle multi-link structure b, and a wing trailing edge multi-link structure c, which are arranged in sequence from the head to the tail of the main body of the aircraft, and the total lengths of which decrease in turn. The wing leading edge multi-link structure a, the wing middle multi-link structure b, and the wing trailing edge multi-link structure c are all connected with a support frame d on the main body of the aircraft. The movement of the multi-link structures a, b, and c is driven by the motors at their corresponding joints to rotate, and the relative rotation directions of the motors are not limited. The wing element structure, the wing structure and the aircraft will be described in detail below in conjunction with specific embodiments.

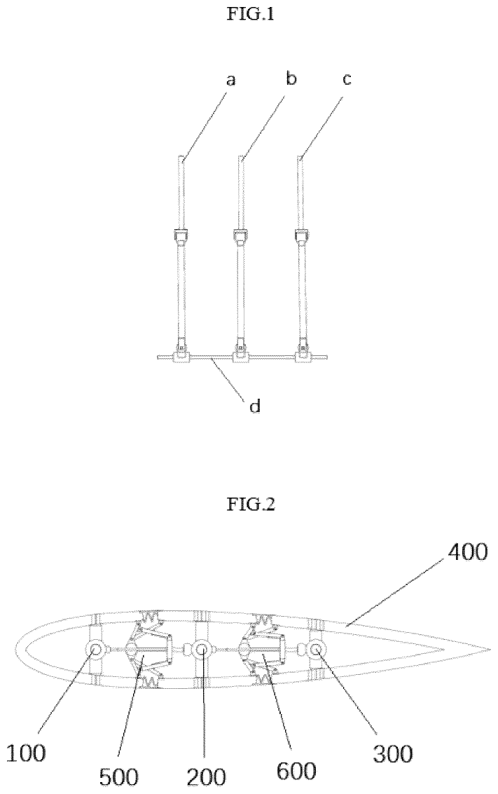

A first aspect of the embodiment of the present disclosure provides a multi-dimensional deformable wing element structure, each of the wing element structures is successively sleeved on the wing leading edge multi-link structure, the wing middle multi-link structure and the wing trailing edge multi-link structure to form the wing structure. As shown in FIG. 2, the wing structure includes a wing leading edge link 100, a wing middle link 200 and a wing trailing edge link 300, which are arranged in sequence. Here, the extension directions of the wing leading edge link 100, the wing middle link 200 and the wing trailing edge link 300 are dewing elemented as a first direction, wherein the wing leading edge link 100, the wing middle link 200 and the wing trailing edge link 300 are respectively the links on the leading edge multi-link structure, the middle multi-link structure and the trailing edge multi-link structure. Each of the wing element structures is sleeved on the wing leading edge link 100, the wing middle link 200 and the wing trailing edge link 300 along a second direction which may be perpendicular to the first direction; the movement of the wing leading edge link 100, the wing middle link 200 and the wing trailing edge link 300 driven by a driving device (such as a motor) can drive the movement of the wing element structure, and thus, the overall movement of the wing structure is driven.

Each of the wing element structures involved in the embodiments of the present disclosure includes a plurality of wing element units, and the adjacent wing element units are connected by the airfoil control unit and a wing element outer edge connector. Each of the wing element units includes a plurality of wing element edge pieces and a wing link connector. The wing link connector in each of the wing element units is connected to the wing lever group of the aircraft. The different wing links of the aircraft may swing relatively up and down, left and right, or the like, that is, the relative position changes. The wing lever group here is the wing leading edge link 100, the wing middle link 200 or the wing trailing edge link 300; in each of the wing element structures, the wing element edge piece and the wing element outer edge connector constitute awing element outer frame 400 of the wing element structure.

In an embodiment of the present disclosure, the wing element structure includes a wing element leading edge unit and a wing element trailing edge unit. In some embodiments, at least one wing element middle unit may be disposed between the wing element leading edge unit and the wing element trailing edge unit, wherein the number of the wing element middle units here may be one, or may be multiple. The number of the wing elemente middle units may be set according to the overall length of the wing element structure, the deformation requirements of the wing element structure, and the like. In the embodiment of the present disclosure, the number of the wing element middle units is one. The wing leading edge unit, the wing middle unit and the wing trailing edge unit are respectively connected with the wing leading edge link 100, the wing middle link 200 and the wing trailing edge link 300. Further, as shown in FIG. 2, the wing element leading edge unit and the wing element middle unit are connected through a first airfoil control unit 500, and the wing element middle unit and the wing element trailing edge unit are connected through a second airfoil control unit 600.

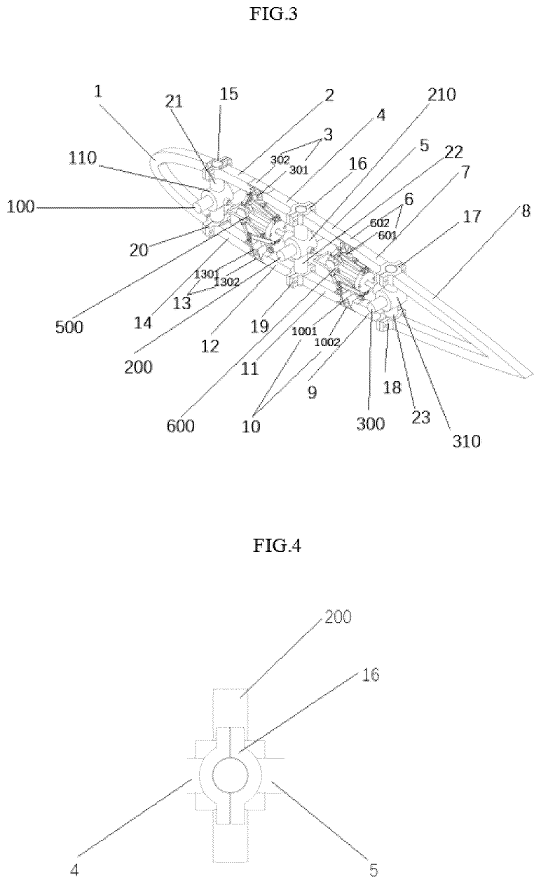

Specifically, by referring to FIG. 3 and in conjunction with FIG. 2, FIG. 3 shows a structural schematic diagram of the wing element structure. The wing element leading edge unit is located at the leading edge position of the wing element unit, and includes awing element leading-edge arc piece 1, a first wing element edge piece 2, an eighth wing element edge piece 14 and the wing leading edge link connector 110. First ends of the first wing element edge piece 2 and of the eighth wing element edge piece 14 are respectively connected with a first end and a second end of the wing element leading edge arc piece 1 and are respectively located on the upper and lower sides of the wing element leading edge unit, which can realize passive deformation; second ends of the first wing element edge piece 2 and of the eighth wing element edge piece 14 are respectively connected with a first rotary bearing 15 and a sixth rotary bearing 20, the first rotary bearing 15 and the sixth rotating bearing 20 are connected through a first wing element unit support 21 which passes through and is connected with the wing leading edge link connector 110, wherein the first rotary bearing 15 and the sixth rotary bearing 20 are slidable on the first wing element unit support 21.

The wing element middle unit is located in the middle of the wing element unit, and includes a second wing element edge piece 4, a third wing element edge piece 5, a sixth wing element edge piece 11, a seventh wing element edge piece 12 and a wing middle link connector 210, wherein the second wing element edge piece 4 and the third wing element edge piece 5 are located on the upper side of the wing element middle unit, and the sixth wing element edge piece 11 and the seventh wing element edge piece 12 are located on the lower side of the wing element middle unit, the wing element edge pieces here capable of achieving passive deformation; first ends of the second wing element edge piece 4 and of the third wing element edge piece 5 are connected through a second rotary bearing 16, the sixth wing element edge piece 11 and the seventh wing element edge piece 12 are connected through a fifth rotary bearing 19, the second rotary bearing 16 and the fifth rotary bearing 19 are connected through a second wing element unit support 22, and the second wing element unit support 22 passes through and is connected with the wing middle link connector 210; wherein, FIG. 4 exemplarily shows that the first end of the second wing element edge piece 4 is connected with the first end of the third wing element edge piece 5 through the second rotary bearing 16, and this connection structure is suitable for other rotary bearings; the second rotary bearing 16 and the fifth rotary bearing 19 are slidable on the second wing element unit support 22. In some embodiments, the second wing element edge piece 4, the third wing element edge piece 5, the sixth wing element edge piece 11 and the seventh wing element edge piece 12 can also be replaced by a rigid link.

The wing element trailing edge unit is located at the trailing edge position of the wing element unit, and includes a wing element trailing edge wedge piece 8, a fourth wing element edge piece 7, a fifth wing element edge piece 9 and a wing trailing edge link connector 310. First ends of the fourth wing element edge piece 7 and of the fifth wing element edge piece 9 are respectively connected with a first end and a second end of the wing element trailing edge wedge piece 8 and are respectively located on the upper and lower sides of the wing element trailing edge unit, thereby realizing passive deformation; second ends of the fourth wing element edge piece 7 and of the fifth wing element edge piece 9 are respectively connected with a third rotary bearing 17 and a fourth rotary bearing 18, the third rotary bearing 17 and the fourth rotary bearing 18 are connected through a third wing element unit support 23, and the third wing element unit support 23 passes through and is connected with the wing trailing edge link connector 310, wherein the third rotary bearing 17 and the fourth rotary bearing 18 are slidable on the third wing element unit support 23.

Further, the wing leading edge link connector 110, the wing middle link connector 210 and the wing trailing edge link connector 310 are respectively disposed on the wing leading edge link 100, the wing middle link 200 and the wing trailing edge link 300.

As described above, the wing element units are connected through the airfoil control unit. Specifically, the wing leading edge link connector 110, the wing middle link connector 210 and the wing trailing edge link connector 310 are connected through the airfoil control units. Specifically, the wing leading edge link connector 110 and the wing middle link connector 210 are connected through a first airfoil control unit 500, and the wing middle link connector 210 and the wing trailing edge link connector 310 are connected through a second airfoil control unit 600. Considering that the movement of the wing leading edge link 100, the wing middle link 200 and the wing trailing edge link 300 driven by a driving device (such as a motor) can drive the overall movement of the wing element structure. The wing leading edge link connector 110, the wing middle link connector 210 and the wing trailing edge link connector 310 may be, for example, the rotor of a motor or a bushing, so active driving motion or passive motion can be realized. The specific selection is determined based on factors such as requirements and position of the aircraft, which is not limited in the present disclosure.

Further, as mentioned above, the wing element edge pieces of different wing element units are connected through the wing element outer edge connector. In the embodiment of the present disclosure, the wing element leading edge unit and the wing element middle unit are connected on the upper and lower sides respectively by the first wing element outer edge connector 3 and the fourth wing element outer edge connector 13, and the wing element middle unit and the wing element trailing edge unit are connected on the upper and lower sides respectively by the second wing element outer edge connector 6 and the third wing element outer edge connector 10. Wherein, on one side of the wing element structure, the first wing element outer edge connector 3 includes a retractable first flexible connector 301 and a first sliding cover 302, the first flexible connector 301 and the first sliding cover 302 are arranged between the end face of the first wing element edge piece 2 of the wing element leading edge unit and the end face of the second wing element edge piece 4 of the wing element middle unit; the second wing element outer edge connector 6 includes a retractable second flexible connector 601 and a second sliding cover 602, and the second flexible connector 601 and the second sliding cover 602 are arranged between the end faces of the third wing element edge piece 5 and the fourth wing element edge piece 7 of the wing element middle unit. On the other side of the wing element structure, the third wing element outer edge connector 10 includes a retractable third flexible connector 1001 and a third sliding cover 1002. The third flexible connector 1001 and the third sliding cover 1002 are arranged between the end face of the fifth wing element edge piece 9 of the wing element trailing edge unit and the end face of the sixth wing element edge piece 11 of the wing element middle unit; the fourth wing element outer edge connector 13 includes a retractable fourth flexible connector 1301 and a fourth sliding cover 1302, the fourth flexible connector 1301 and the fourth sliding cover 1302 are arranged between the end faces of the seventh wing element edge piece 12 of the wing element middle unit and the end face of the eighth wing element edge piece 14 of the wing element leading edge unit.

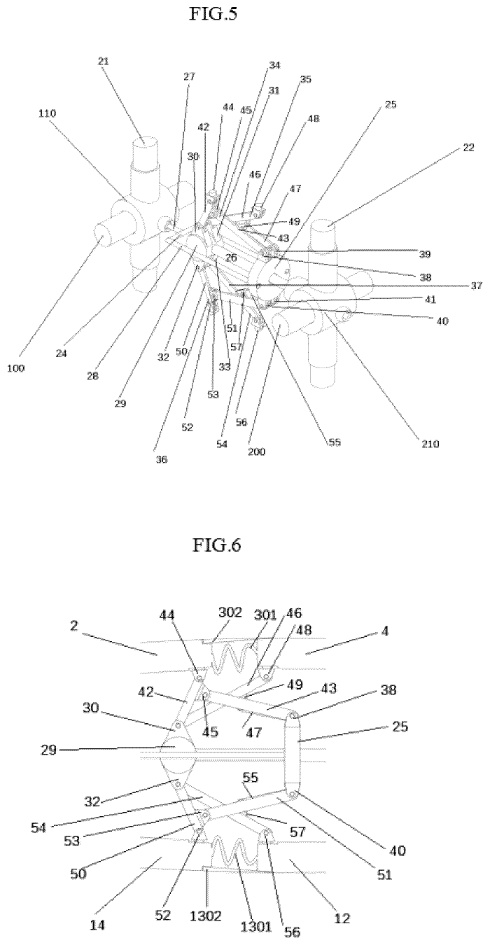

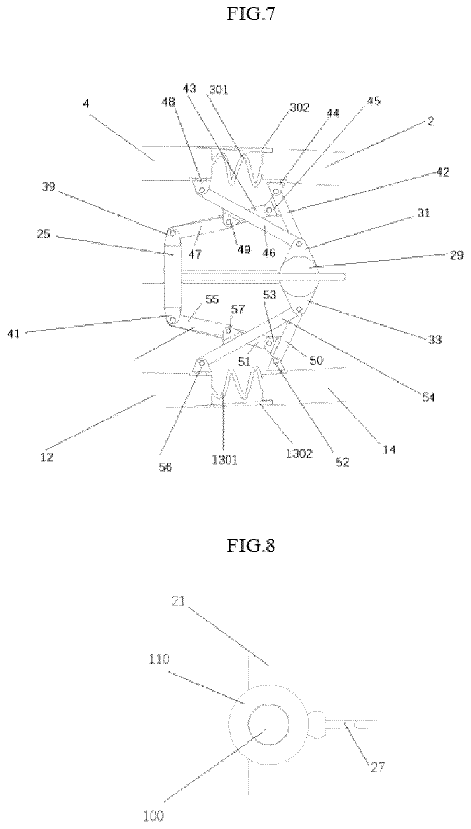

As mentioned above, the wing element leading edge unit and the wing element middle unit are connected through the first airfoil control unit 500. Specifically, the wing leading edge link connector 110 and the wing middle link connector 210 are connected through the first airfoil control unit 500, and as shown in FIGS. 5-7, FIG. 5 shows the three-dimensional structure of the first airfoil control unit 500 and its connection relationship with the wing leading edge link connector 110 and the wing middle link connector 210, and FIG. 6 and FIG. 7 further respectively illustrate the structure of the first airfoil control unit 500 and its connection relationship with the wing leading edge link connector 110 and the wing middle link connector 210 from two sides.

The first airfoil control unit 500 includes a first slip ring link 24, a first slip ring 25 and a first sliding rod 26. Specifically, one end of the first slip ring link 24 is connected to the side of the wing leading edge link connector 110 opposite to the wing middle link connector 210, the other end of the first slip ring link 24 is connected to the first slip ring 25, the first sliding rod 26 is arranged on the side of the wing middle link connector 210 opposite to the wing leading edge link connector 110, and the first sliding ring 25 is sleeved on the first sliding rod 26 and can slide back and forth along the first sliding rod 26.

Specifically, the first slip ring link 24 includes a first straight rod 27 and a first U-shaped rod 28. One end of the first straight rod 27 is connected to the side of the wing leading edge link connector 110 As shown in FIG. 8, the first straight rod 27 and the wing leading edge link connector 110 can be connected by a ball hinge, the other end of the first straight rod 27 is connected to the bottom edge of the first U-shaped rod 28, the two long sides of the first U-shaped rod 28 are respectively connected with the first slip ring 25, and the first sliding rod 26 passes through the middle of the first slip ring 25 and is located in the middle of the two long sides.

Further, a first sliding rod base 29 is provided on the top of the first sliding rod 26, and is limited in the annular area enclosed by the first U-shaped rod 28 and the first slip ring 25. The upper side of the first sliding rod base 29 is provided with a first sliding rod base hinge support 30 and a second sliding rod base hinge support 31 side by side, and correspondingly, the lower side of the first sliding rod base 29 is provided with a third sliding rod base hinge support 32 and a fourth sliding rod base hinge support 33 side by side. The first sliding rod base hinge support 30 is connected with one end of a first lever group 34, and the other end of the first lever group 34 is connected with the first slip ring 25; the second sliding rod base hinge support 31 is connected with one end of a second lever group 35, and the other end of the second lever group 35 is connected with the first slip ring 25; the third sliding rod base hinge support 32 is connected with one end of a third lever group 36, and the other end of the third lever group 36 is connected is connected with the first slip ring 25; the fourth sliding rod base hinge support 33 is connected with one end of a fourth lever group 37, and the other end of the fourth lever group 37 is connected with the first slipring 25. In this way, the first sliding rod base 29 is rotatably connected to the first slip ring 25 through four lever groups.

Further, a first slip ring hinge support 38 and a second slip ring hinge support 39 are provided at the end of the first slip ring 25 on a first side, wherein the other end of the first lever group 34 is rotatably connected to the first slip ring hinge support 38 of the first slip ring 25, and the other end of the second lever group 35 is rotatably connected to the second slip ring hinge support 39 of the first slip ring 25. A third slip ring hinge support 40 and a fourth slip ring hinge support 41 are provided at the end of the first slip ring 25 on a second side, wherein the other end of the third lever group 36 is rotatably connected to the third slip ring hinge support 40 of the slip ring 25, and the other end of the fourth lever group 37 is rotatably connected to the fourth slip ring hinge support 41 of the first slip ring 25.

Specifically, the first lever group 34 includes a first rod 42 and a second rod 43. A first end of the first rod 42 is rotatably connected with the sliding rod base hinge support 30, and a first hinge support 44 and a second hinge support 45 are respectively provided at a second end and the middle of the first rod 42, wherein the second end of the first rod 42 is connected with the first wing element edge piece 2 through the first hinge support 44. A first end of the second rod 43 is connected with the first rod 42 through the second hinge support 45, and a second end of the second rod 43 is rotatably connected with the first slip ring hinge support 38.

The second lever group 35 includes a third rod 46 and a fourth rod 47. A first end of the third rod 46 is rotatably connected to the second sliding rod base hinge support 31, and a third hinge support 48 and a fourth hinge support 49 are respectively provided at a second end and the middle of the third rod 46, wherein the second end of the third rod 46 is connected with the second wing element edge piece 4 through the third hinge support 48. A first end of the fourth rod 47 is connected with the third rod 46 through the fourth hinge support 49, and a second end of the fourth rod 47 is rotatably connected with the second slip ring hinge support 39.

The third lever group 36 includes a fifth rod 50 and a sixth rod 51. A first end of the fifth rod 50 is rotatably connected to the third sliding rod base hinge support 32, and a fifth hinge support 52 and a sixth hinge support 53 are respectively provided at a second end and the middle of the fifth rod 50, wherein the second end of the fifth rod 50 is connected with the eighth wing element edge piece 14 through the fifth hinge support 52. A first end of the sixth rod 51 is connected to the fifth rod 50 through the sixth hinge support 53, and a second end of the sixth rod 51 is rotatably connected to the third slip ring hinge support 40.

The fourth lever group 37 includes a seventh rod 54 and an eighth rod 55. A first end of the seventh rod 54 is rotatably connected to the fourth sliding rod base hinge support 33, and a seventh hinge support 56 and an eighth hinge support 57 are respectively provided at a second end and the middle of the seventh rod 54, wherein the second end of the seventh rod 54 is connected to the seventh wing element edge piece 12 through the seventh hinge support 56. A first end of the eighth rod 55 is connected to the seventh rod 54 through the eighth hinge support 57, and a second end of the eighth rod 55 is rotatably connected to the fourth slip ring hinge support 41.

In this way, each lever group can form a rotational connection with the wing element edge piece in the wing element outer frame 400 through the hinge support, so as to realize the linkage relationship between the airfoil control unit and the wing element outer frame 400. The following is a detailed description of the motion control of the first airfoil control unit 500 located at the front of the wing element.

In the actual movement of the wing element structure, as long as the relative position between the wing leading edge link 100 and the wing middle link 200 changes, whether it is swinging in the horizontal plane or swinging in the vertical plane, or the combined movement in the horizontal and vertical planes, the first sliding rod 26 will be caused to move relative to the first slip ring 25; further, because there is a linkage relationship between the airfoil control unit and the wing element outer frame, through the first sliding rod base hinge support 30, the second sliding rod base hinge support 31, the third sliding rod base hinge support 32, the fourth sliding rod base hinge support 33, the first slip ring hinge support 38, the second slide ring hinge support 39, the third slip ring hinge support 40 and the fourth slip ring hinge support 41 fixed on the first slip ring 25 and the first sliding rod 26, the relative motion between the first sliding rod 26 and the first slip ring 25 is respectively passed to the first rod 42, the second rod 43, the third rod 46, the fourth rod 47, the fifth rod 50, the sixth rod 51, the seventh rod 54 and the eighth rod 55, wherein a linkage relationship is generated between the first rod 42 and the second rod 43 through the second hinge support 45, a linkage relationship is generated between the third rod 46 and the fourth rod 47 through the fourth hinge support 49, a linkage relationship is generated between the fifth rod 50 and the sixth rod 51 through the sixth hinge support 53, and a linkage relationship is generated between the seventh rod 54 and the eighth rod 55 through the eighth hinge support 57. In addition, since the relative motion of the first slip ring 25 and the first sliding rod 26 is passed to the first hinge support 44, the third hinge support 48, the fifth hinge support 52 and the seventh hinge support 56, the relative motion of the first slip ring 25 and the first sliding rod 26 is passed to the first wing element edge piece 2, the second wing element edge piece 4, the seventh wing element edge piece 12 and the eighth wing element edge piece 14 which are passively deformable, so that the first wing element edge piece 2, the second wing element edge piece 4, the seventh wing element edge piece and the eighth wing element edge piece 14 which are passively deformable, can follow the relative movement of the first slip ring 25 and the first sliding rod 26 to achieve movement.

Further, with the movement of the first wing element edge piece 2, the second wing element edge piece 4, the seventh wing element edge piece 12 and the eighth wing element edge piece 14, a first sealing flexible connector 301 and a fourth sealing flexible connector 1301 that form a flexible connection between the adjacent wing element edge pieces will also produce telescopic motion, wherein one end of the first sliding cover 302 is fixedly connected with the first wing element edge piece 2, and the other end (moving end) is slidably connected with the second wing element edge piece 4. Along with the relative movement of the first wing element edge piece 2 and the second wing element edge piece 4, the moving end of the first sliding cover 302 is always closely attached to the second wing element edge piece 4. In addition, one end of the fourth sliding cover 1302 is fixed on the eighth wing element edge piece 14, the other end is slidably connected to the seventh wing element edge piece 12 as a moving end. With the relative movement of the eighth wing element edge piece 14 and the seventh wing element edge piece 12, the moving end of the fourth sliding cover 1302 is always closely attached to the seventh wing element edge piece 12.

In order to enable the first airfoil control unit 500 at the front of the wing element to still achieve airfoil control capability under the complex deformation of the first wing element edge piece 2, the second wing element edge piece 4, the seventh wing element edge piece 12 and the eighth wing element edge piece 14, and to pass the relative motion of the first slip ring 25 and the first sliding rod 26, the first slip ring link 24 and the wing leading edge link connector 110 are connected by a ball hinge, and the first sliding rod 26 and the wing middle link connector 210 are connected by a ball hinge. Further, taking FIG. 9 as an example, the third hinge support 48 is connected to the second wing element edge piece 4 through a rotating shaft 48a. Similarly, the first hinge support 44 is connected to the first wing element edge piece 2 through a rotating shaft 44, the fifth hinge support 52 is connected with the eighth wing element edge piece 14 through a rotating shaft, and the fourth hinge support 56 is connected with the seventh wing element edge piece 12 through a rotating shaft, so as to ensure that the first sliding rod 26 can easily slide on the first slip ring 25 under the deformation of the wing element outer frame 400.

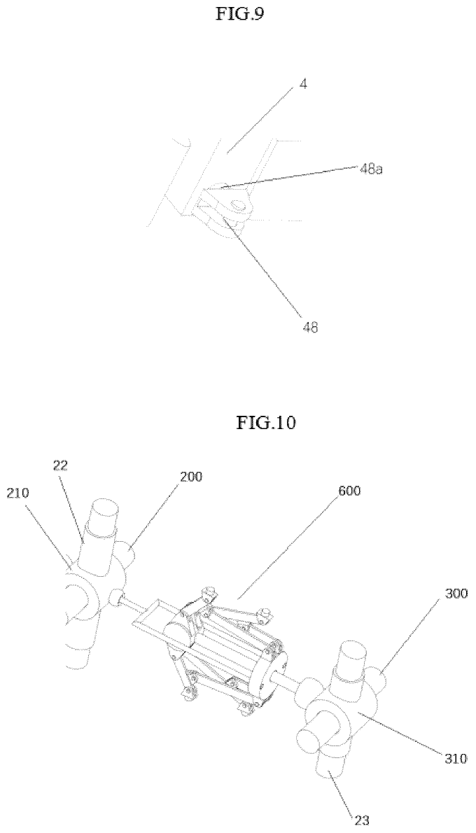

As described above, the wing middle link connector 210 and the wing trailing edge link connector 310 are connected through the second airfoil control unit 600. As shown in FIG. 10, FIG. 10 shows the three-dimensional structure of the second airfoil control unit 600 and its connection relationship with the wing middle link connector 210 and the wing trailing edge link connector 310. The structure of the second airfoil control unit 600 is the same as that of the first airfoil control unit 500, which will not be elaborated here in the present disclosure.

With the wing element structure of this embodiment, based on the adjustment of the airfoil control unit, for example, through the movement of the wing lever group or the change of the relative position, the movement of the wing element structure can be realized, that is, a variety of airfoil deformation, so as to realize the basic action of plane airfoil transformation.

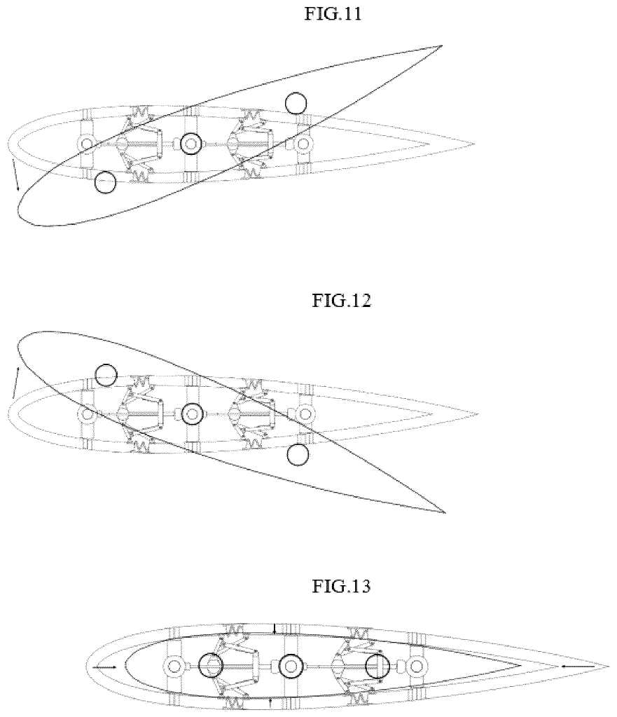

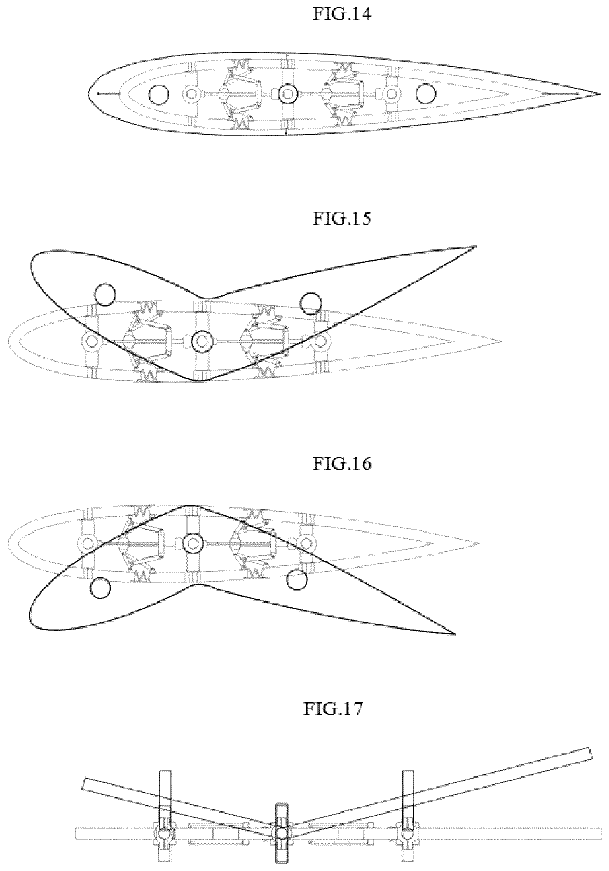

FIGS. 11 and 12 are schematic diagrams of changes in airfoil angle of attack, in which through the movement of the wing structure, the sections of the wing element structure where the wing leading edge link 100, the wing middle link 200, and the wing trailing edge link 300 are located are in the same straight line, and thus, the lowering action shown in FIG. 11 and the raising action shown in FIG. 12 are realized. Of course, as shown in FIGS. 13 and 14, the embodiment of the present disclosure can also realize the change of the wing element structure, that is, the expansion and contraction of the airfoil. For example, the two airfoil control units drive the wing element structure to contract, for example, through the relative movement between the first slip ring link 24 and the first sliding rod 26, so that the distance between the wing leading edge link 100, the wing middle link 200, and the wing the trailing edge links 300 is shortened, so as to realize the airfoil contracting action shown in FIG. 13; or the two airfoil control units drive the wing element structure to increase, that is, the distance between the wing leading edge link 100, the wing middle link 200, and the wing trailing edge links 300 is increased, so as to realize the airfoil increasing action shown in FIG. 14. The embodiment of the present disclosure can also realize the airfoil plane bending action. FIGS. 15 and 16 are schematic diagrams of the airfoil plane bending action of the wing element structure, wherein FIG. 15 shows a schematic diagram of the upward bending of the wing element structure, and FIG. 16 shows a schematic diagram of the downward bending of the wing element structure.

Of course, the above-mentioned airfoil changing actions can be combined to realize the complex action of plane airfoil transformation: this type of transformation is the arrangement and combination of the basic actions of the plane airfoil, which belongs to the combined movement and may realize the complex transformation of the airfoil, which will not be further discussed here in this disclosure.

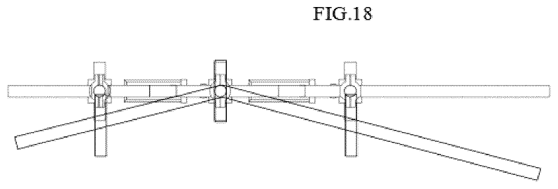

Through the wing element structure of this embodiment, based on the adjustment of the airfoil control unit, various airfoil deformations can be realized, and complex actions of space airfoil transformation can also be realized. This kind of complex transformation is based on the change of the angle of attack of the plane airfoil transformation basic action, similar tensile and compressive deformation, and plane bending, and can add the basic motion of the wing element's lateral twist caused by the non-parallel motion of the wing leading edge link 100, the wing middle link 200 and the wing trailing edge link 300. Since the spatial airfoil transformation is difficult to describe in detail with a two-dimensional image, only the side twisting motion of the wing element is supplemented here. The complex transformation of the spatial airfoil is based on the arrangement and combination of four basic motions, namely the change of angle of attack, similar deformation, plane bending and side twisting. FIGS. 17 and 18 show schematic diagrams of two side twists of the side twist of the wing element structure.

A second aspect of the embodiments of the present disclosure provides a wing structure including the wing element structure in any of the foregoing embodiments. The wing structure here is composed of the wing element structure, which is arranged at any position on the main body of the aircraft. For example, the wing element structure can be arranged on the side of the main body of the aircraft, can be arranged on one side, or can be symmetrically arranged on two sides of the main body of the aircraft. The present disclosure does not limit the arrangement position of the wing structure.

The wing structure in the embodiment of the present disclosure includes at least one multi-link structure and the wing element structure. In this way, the twisting deformation of the wing structure can be achieved through the composition of the multi-link structure. Different wing structure forms can be realized according to the number of multi-link structures used in the wing structure, thereby realizing different swing poses and degrees.

The wing structure in the embodiment of the present disclosure has the characteristics of a large-scale deformable wing, and the wing structure has the ability of variable airfoil shape and large-scale variable pitch angle, the ability to swing vertically in a large range along the plane where the main body of the aircraft is located and the ability to swing longitudinally in a large range along the main body of the aircraft. The wing structure can be adjusted for complex flow fields or environments, greatly improve the speed and efficiency of movement, and achieve high maneuverability.

A third aspect of the embodiments of the present disclosure provides a flapping-wing aircraft, which includes the wing structure in any of the foregoing embodiments. The flapping-wing aircraft here can realize sailing or flying, gliding and other high maneuvering actions based on the swing of the wing structure in the air or in the water. The structure of the aircraft here can be a bionic structure such as a bionic bird, a bionic fish, or the like, and may also be a structure such as an aircraft-type biplane. The present disclosure does not limit the specific structure of the aircraft.

The wing element structure, the wing structure and the flapping-wing aircraft in the embodiments of the present disclosure all have the characteristics of a large-scale deformable wing in the chordwise and spanwise directions. The wing structure has the ability of variable airfoil shape and large-scale variable pitch angle, the ability to swing vertically in a large range along the plane where the main body of the aircraft is located and the ability to swing longitudinally in a large range along the main body of the aircraft. The wing structure can be adjusted for complex flow fields or environments, greatly improve the speed and efficiency of movement, and achieve high maneuverability.

Furthermore, exemplary embodiments have been described herein, and the scope includes any and all embodiments based on the present disclosure with equivalent elements, modifications, omissions, combinations (e.g., where various embodiments intersect), adaptations, or alterations. Elements in the claims are to be construed broadly based on the language employed in the claims, and are not to be limited to the examples described in this specification or during the practice of this application, the examples of which are to be construed as non-exclusive. Therefore, this specification and examples are intended to be regarded as examples only, with the true scope and spirit being indicated by the following claims along with the full scope of equivalents thereof.

The above description is intended to be illustrative but not restrictive. For example, the above examples (or one or more schemes thereof) may be used in combination with each other. For example, other embodiments may be utilized by those of ordinary skill in the art upon reading the above description. Additionally, in the above Detailed Description, various features may be grouped together to simplify the present disclosure. This should not be construed as an intention that an unclaimed disclosed feature is essential to any claim. Rather, presently disclosed subject matter may lie in less than all features of a particular disclosed embodiment. Thus, the following claims are hereby incorporated into the Detailed Description by way of example or embodiment, with each claim standing on its own as a separate embodiment, and it is contemplated that these embodiments may be combined with each other in various combinations or permutations.

The scope of the disclosure should be determined with reference to the appended claims, along with the full scope of equivalents to which such claims are entitled. The above embodiments are only exemplary embodiments of the present disclosure, and are not intended to limit the present disclosure. The protection scope of the present disclosure is dewing elemented by the claims. Those skilled in the art can make various modifications or equivalent replacements to the present disclosure within the spirit and protection scope of the present disclosure, and such modifications or equivalent replacements should also be regarded as falling within the protection scope of the present disclosure.

What is claimed is:

1. A wing element structure, characterized by including a plurality of wing element units, the adjacent wing element units being connected by an airfoil control unit and awing element outer edge connector, wherein each of the wing element units includes a plurality of interconnected wing element edge pieces and a wing link connector, and the wing link connector in each of the wing element units is correspondingly connected to a wing lever group of an aircraft.

2. The wing element structure according to claim 1, wherein the plurality of wing element units comprise a wing element leading edge unit and a wing element trailing edge unit, and at least one wing element middle unit is disposed between the wing element leading edge unit and the wing element trailing edge unit.

3. The wing element structure according to claim 2, wherein the wing element leading edge unit comprises a wing element leading edge arc piece, a first wing element edge piece, an eighth wing element edge piece, and a wing leading edge link connector, first ends of the first wing element edge piece and of the eighth wing element edge piece are respectively connected with a first end and a second end of the wing element leading edge arc piece, and second ends of the first wing element edge piece and of the eighth wing element edge piece are respectively connected with a first rotary bearing and a sixth rotary bearing, the first rotary bearing and the sixth rotating bearing being connected through a first wing element unit support which passes through and is connected with the wing leading edge link connector.

4. The wing element structure according to claim 2, wherein the wing element trailing edge unit comprises awing element trailing edge wedge piece, a fourth wing element edge piece, a fifth wing element edge piece and a wing trailing edge link connector, first ends of the fourth wing element edge piece and of the fifth wing element edge piece are respectively connected with a first end and a second end of the wing element trailing edge wedge piece, and second ends of the fourth wing element edge piece and of the fifth wing element edge piece are respectively connected with a third rotary bearing and a fourth rotary bearing, the third rotary bearing and the fourth rotary bearing being connected through a third wing element unit support which passes through and is connected with the wing trailing edge link connector.

5. The wing element structure according to claim 2, wherein the wing element middle unit comprises a second wing element edge piece, a third wing element edge piece, a sixth wing element edge piece, a seventh wing element edge piece and a wing middle link connector, first ends of the second wing element edge piece and of the third wing element edge piece are connected through a second rotary bearing, and first ends of the sixth wing element edge piece and of the seventh wing element edge piece are connected through a fifth rotary bearing, the second rotary bearing and the fifth rotary bearing being connected through a second wing element unit support which passes through and is connected with the wing middle link connector.

6. The wing element structure according to claim 1, wherein the wing element edge pieces of adjacent wing element units are connected by the wing element outer edge connector, and the wing element outer edge connector includes a flexible connector and a sliding cover, the flexible connector telescopically connects the adjacent wing element edge pieces, one end of the sliding cover is fixedly connected with an end of one of the wing element edge pieces connected, and the other end of the sliding cover is slidably connected with an end of another adjacent wing element edge piece.

7. The wing element structure according to claim 1, wherein the airfoil control unit comprises a slip ring link, a slip ring and a sliding rod, one end of the slip ring link is connected to a side of a first wing link connector of the first wing element unit, the other end of the slip ring link is connected to the slip ring, the sliding rod is arranged on a side of a second wing link connector of the second wing element unit adjacent to the first wing element unit and extends toward the direction of the first wing link connector, and the sliding ring is sleeved on the sliding rod and can slide back and forth along the sliding rod.

8. The wing element structure according to claim 7, wherein a sliding rod base is provided on the top of the sliding rod, two sliding rod base hinge supports are respectively provided on the opposite first and second sides of the sliding rod base, and each of the sliding rod base hinge supports is connected with a corresponding slip ring hinge support on the slip ring through a lever group.

9. The wing element structure according to claim 7, wherein on the first side or the second side of the sliding rod base, the lever group comprises a front rod and a rear rod that are connected to each other, a first end of the front rod is connected with the corresponding sliding rod base hinge support, a second end of the front rod is connected with the corresponding wing element edge piece through a hinge support, the middle part of the front rod is connected to a first end of the rear rod through another hinged support, and a second end of the rear rod is connected to the corresponding slip ring hinge support on the slip ring.

10. A wing structure comprising the wing element structure of claim 9.

11. A flapping-wing aircraft employing the wing structure of claim 10.
